(19) United States
(12) Patent Application Publication
(10) Pub. No.: US 2003/0057307 A1
(43) Pub. Date: Mar. 27, 2003

(54) Control member for preventing fishing line activating button being pushed

(76) Inventor: Han-Chi Lu, Taichung City (TW)

Correspondence Address: Hart, Baxley, Daniels & Holton, 59 John Street, Fifth Floor, New York, NY, 10038, US

(21) Appl. No.: 09/960,778

(22) Filed: Sep. 24, 2001

(51) Int. Cl. A01K 89/01

(52) U.S. Cl. 242/239

(57) ABSTRACT

A fishing reel includes a casing having an opening defined therein and a button is pivotally engaged with the opening. A fishing line mechanism is received in the casing and located beneath the button. A slot is defined through the casing and a control member is slidably engaged with the slot so that the control member can be slid between the button and the fishing line mechanism to prevent the button from being pushed to activate the fishing line mechanism.

### FIELD OF THE INVENTION

The present invention relates to a fishing reel that has a fishing line activating button and a control member slidably engaged with the casing of the reel. The control member can be slid to a position to prevent the button from being pushed.

### BACKGROUND OF THE INVENTION

A conventional fishing reel is shown in FIG. 1 and generally includes casing 11 that has a fishing line spinning mechanism 10 received therein. An opening 12 is defined in the casing 11 and an activating button 13 is pivotally engaged with the opening 12 so that when the button 13 is pushed by the user, the fishing line spinning mechanism 10 is activated. The activating button 13 is located close to the thumb of the user so that the user may conveniently push the button 13 when needed. However, during the enjoy of the fishing, the activating button 13 is often touched unintentionally by the user and the fishing line is unexpected to be released. Such unintentional action makes the fishing line shakes in the water and disturbs the fishes.

### SUMMARY OF THE INVENTION

In accordance with one aspect of the present invention, there is provided a fishing reel which comprises a casing having an opening defined therein so that a button is pivotally engaged with the opening and can activate a fishing line mechanism received in the casing. A slot is defined through the casing and a control member is slidably engaged with the slot and located between the button and the fishing line mechanism.

The primary object of the present invention is to provide a control member slidably engaged with the casing of the fishing reel so as to be slid between the button and the fishing line mechanism to prevent the button from being pushed unintentionally.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a side view to show a conventional fishing reel;

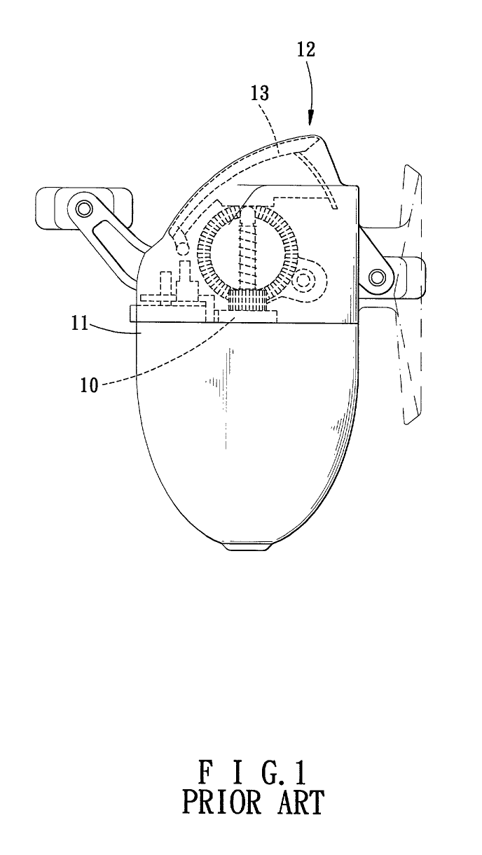

FIG. 2 is a perspective view to show the fishing reel of the present invention;

FIG. 3 is a side view to show the fishing reel of the present invention;

FIG. 4 is a top view to show the control member is located away from the button, and

FIG. 5 is a top view to show that the control member is slid between the button and the fishing line mechanism.

### DETAILED DESCRIPTION OF THE PREFERRED EMBODIMENT

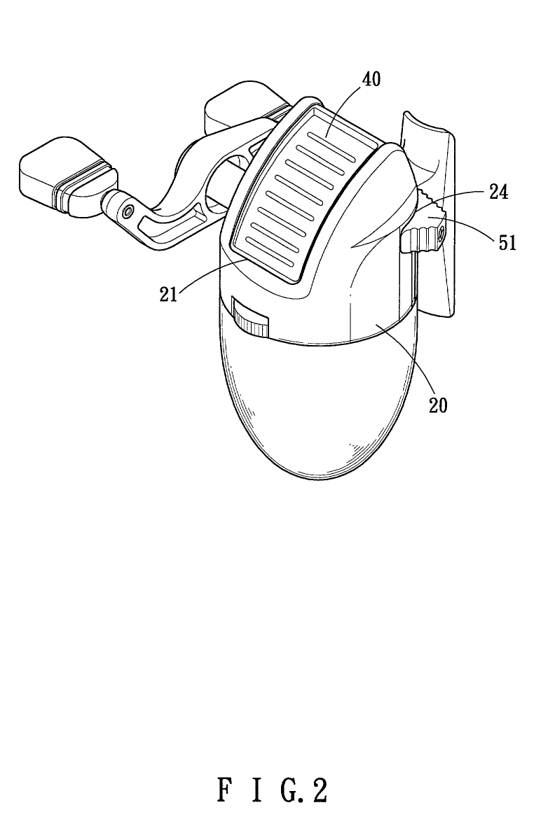

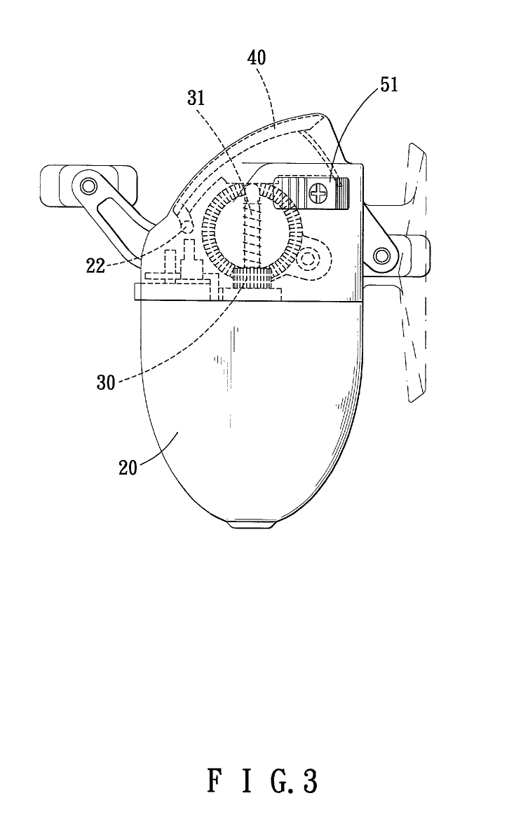

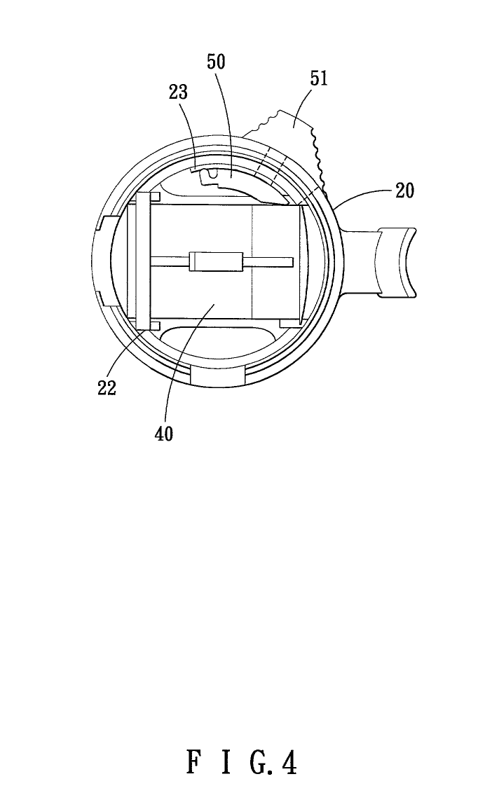

Referring to FIGS. 2, 3, and 4, the fishing reel of the present invention comprises a casing 20 having an opening 21 defined in a top thereof and two support frames 22 are located in an inner periphery of the opening 21. A button 40 is pivotally engaged with the opening 21 by engaging with the two support frames 22. A fishing line mechanism 30 is received in the casing 11 and located beneath the button 40. When the button 40 is pushed, an activation rod 31 of the fishing line mechanism 30 is activated by the button 40 to release the fishing line. A slot 23 is defined through the casing 11 and a control member 50 is slidably engaged with the slot 23. The control member 50 is located between the button 40 and the fishing line mechanism 10. A knob 51 connected to the control member 50 extends from the slot 23 and can be pushed by the user.

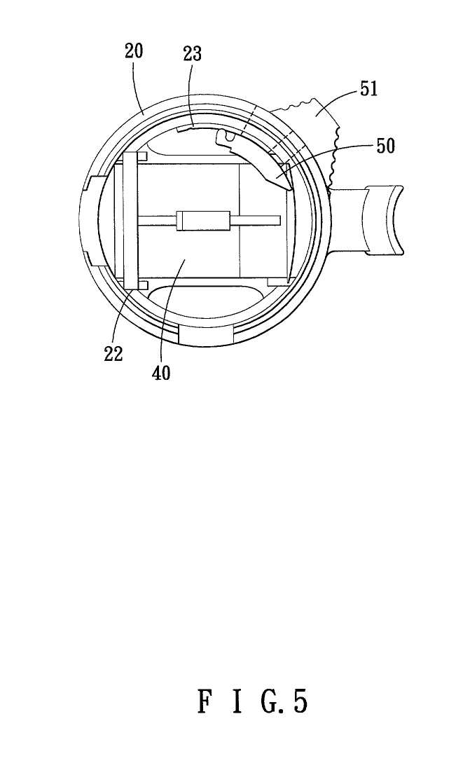

As shown in FIG. 5, when sliding the knob 51 to let the control member 50 be positioned between the button 40 and the fishing line mechanism 30, the button 40 cannot be pushed toward the fishing line mechanism 30. Therefore, the button 40 is not pushed unintentionally by the user.

While we have shown and described the embodiment in accordance with the present invention, it should be clear to those skilled in the art that further embodiments may be made without departing from the scope of the present invention.

What is claimed is:

1. A fishing reel comprising:
a casing having an opening defined therein and a button pivotally engaged with said opening, a fishing line mechanism received in said casing and located beneath said button, a slot defined through said casing, and
a control member slidably engaged with said slot and located between said button and said fishing line mechanism.
